(19) United States
(12) Patent Application Publication
(10) Pub. No.: US 2024/0419961 A1
(43) Pub. Date: Dec. 19, 2024

(54) Iterative Distillation into Memory for Incremental Domain Adaptation

(71) Applicant: INTERNATIONAL BUSINESS MACHINES CORPORATION, ARMONK, NY (US)

(72) Inventors: AMEET DESHPANDE, PRINCETON, NJ (US); ANTHONY FERRITTO, NEW YORK, NY (US); AVIRUP SIL, HOPEWELL JUNCTION, NY (US); MD ARAFAT SULTAN, CROTON-ON-HUDSON, NY (US)

(21) Appl. No.: 18/211,511

(22) Filed: Jun. 19, 2023

(51) Int. Cl. G06N 3/08; G06N 3/045

(52) U.S. Cl. CPC G06N 3/08; G06N 3/045

(57) ABSTRACT

Techniques for incremental domain adaptation are provided using iterative knowledge distillation to sequentially adapt a machine learning model to new tasks, and an external memory bank for storing the machine learning model parameters pertaining to the new tasks. In one aspect, a system for incremental domain adaptation includes: an iterative knowledge distillation module configured to adapt machine learning models to new tasks sequentially through multiple iterations of knowledge distillation; and an external memory bank configured to store parameters of the machine learning models pertaining to the new tasks. The external memory bank can employ adaptive memory allocation. A method for incremental domain adaptation using the present system is also provided.

### FIELD OF THE INVENTION

The present invention relates to machine learning, and more particularly, to techniques for incremental domain adaptation using iterative knowledge distillation to sequentially adapt a machine learning model to new tasks, and an external memory bank for storing the machine learning model parameters pertaining to the new tasks.

### BACKGROUND OF THE INVENTION

With incremental domain adaptation, a machine learning model is sequentially trained on multiple tasks, each of which corresponds to a domain represented by a training dataset. For instance, by this process, an initial machine learning model is first trained on a first task (Task 1), followed by a second task (Task 2), and so on, in order to produce a final model trained on all of the tasks, i.e., Task 1, Task 2 . . . . Task n. The final model is evaluated on all of the tasks for which it was trained.

A goal of incremental domain adaptation is to preserve as much domain knowledge as possible in the trained machine learning model without having to rely on the availability of the associated dataset. Incremental domain adaptation follows a natural human learning progression where, after data is used to learn a certain task (e.g., when a person first learns to walk), one then moves on to different tasks to learn new skills and no longer retains the data from previous tasks. By contrast, traditional multi-task setups train the machine learning model on multiple tasks concurrently. With a multi-task setup, the machine learning model has to be re-trained from scratch every time it encounters a new dataset, which is undesirable.

Incremental domain adaptation seeks to produce a model that performs well on all of the domains that have been encountered. However, there are some notable challenges associated with this approach. For instance, when moving from one task to another, conventional approaches to sequential learning tend to forget what was learned about older tasks. This phenomenon can even lead to catastrophic forgetting where almost all of the knowledge is lost on older tasks. Thus, if the model is sequentially trained on multiple tasks, then it really only performs well on the most recent tasks. Attempts to mitigate the effects of catastrophic forgetting thus far have required a very large memory budget and exhibit poor performance in realistic scenarios.

Thus, improved techniques for incremental domain adaptation which solve the above-described problems would be desirable.

### SUMMARY OF THE INVENTION

The present invention provides techniques for incremental domain adaptation using iterative knowledge distillation to sequentially adapt a machine learning model to new tasks, and an external memory bank for storing the machine learning model parameters pertaining to the new tasks. In one aspect of the invention, a system for incremental domain adaptation is provided. The system includes: an iterative knowledge distillation module configured to adapt machine learning models to new tasks sequentially through multiple iterations of knowledge distillation; and an external memory bank configured to store parameters of the machine learning models pertaining to the new tasks.

In another aspect of the invention, another system for incremental domain adaptation is provided. The system includes: an iterative knowledge distillation module configured to adapt machine learning models to new tasks sequentially through multiple iterations of knowledge distillation; and an adaptive external memory bank configured to store parameters of the machine learning models pertaining to the new tasks in memory slots of the external memory bank, where a number of the memory slots allocated to each of the new tasks varies on a task-by-task basis such that a given one of the new tasks has a different number of the memory slots in the adaptive external memory bank than at least one other of the new tasks.

In yet another aspect of the invention, a method for incremental domain adaptation is provided. The method includes: adapting machine learning models to new tasks sequentially through multiple iterations of knowledge distillation; and storing parameters of the machine learning models pertaining to the new tasks in an external memory bank.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary computing environment according to an embodiment of the present invention;

FIG. 2 is a diagram illustrating an exemplary system for incremental domain adaptation having an iterative knowledge distillation module and an external memory bank according to an embodiment of the present invention;

FIG. 3 is a diagram illustrating an exemplary neural network according to an embodiment of the present invention;

FIG. 4 is a diagram illustrating an exemplary methodology for incremental domain adaptation using iterative knowledge distillation into the external memory bank according to an embodiment of the present invention;

FIG. 5 is a diagram illustrating an exemplary configuration of the present system for incremental domain adaptation where the iterative knowledge distillation module employs a modified transformer-based architecture augmented with memory according to an embodiment of the present invention; and

FIG. 6 is a diagram illustrating an exemplary methodology for incremental domain adaptation according to an embodiment of the present invention.

### DETAILED DESCRIPTION OF PREFERRED EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

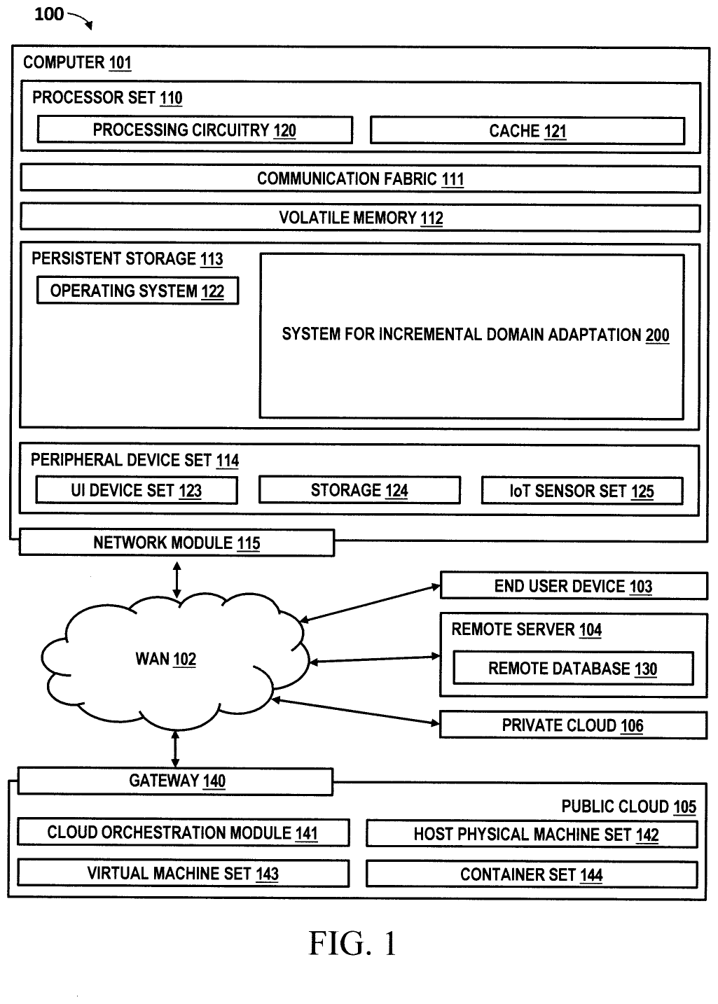

Referring to FIG. 1, computing environment 100 contains an example of an environment for the execution of at least some of the computer code involved in performing the inventive methods, such as system 200 for incremental domain adaptation. In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in system 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As provided above, incremental domain adaptation involves sequentially training a machine learning model on multiple tasks. Each of these tasks corresponds to a domain represented by a training dataset. Thus, the terms ‘domain’ and ‘task’ are used interchangeably herein. One challenge associated with incremental domain adaptation is catastrophic forgetting where the model loses the knowledge it learned on earlier tasks, and has to be retrained. Ideally, during this process a model can be fine-tuned to a specific use without losing the capabilities of the more general model. Take, for instance, the scenario where a user starts with an existing question answering model and optimizes it for the financial domain. The model is now adept at answering finance questions, but should not forget about things it has learned in the past, such as general knowledge, legal industry, etc. topics. Notably, this learning paradigm fits in the framework of life-long learning, where models need to continuously adapt to new incoming data, without forgetting what they have already learned.

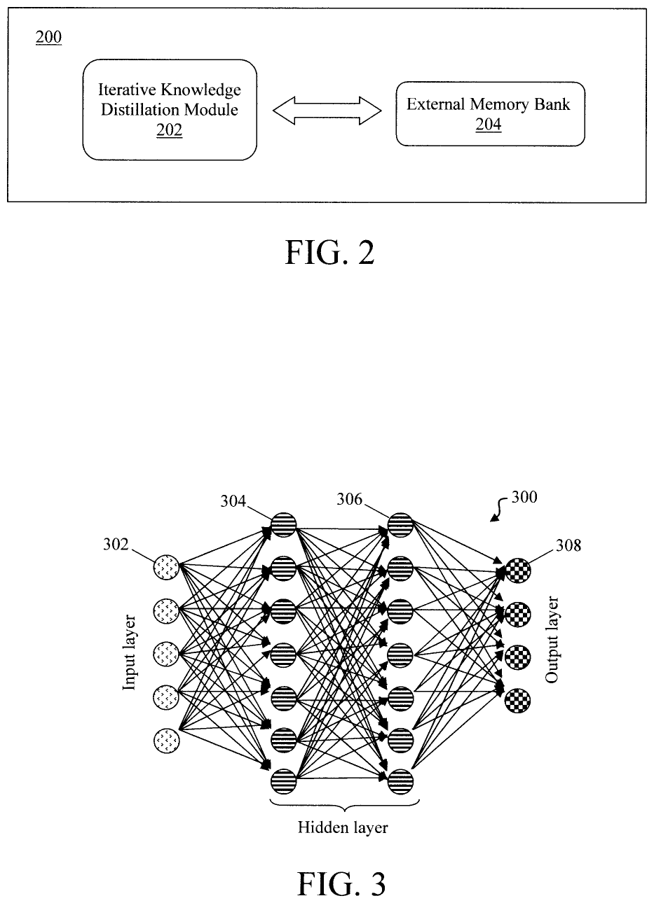

Advantageously, provided herein are incremental domain adaptation techniques that leverage iterative distillation into an external memory bank in order to memorialize the model learning on earlier tasks. For instance, an exemplary configuration of system 200 is provided in FIG. 2. As shown in FIG. 2, embodiments are contemplated herein where system 200 includes an iterative knowledge distillation module 202 and an external memory bank 204. During operation, as machine learning models are iteratively trained by module 202 using knowledge distillation, the parameters (i.e., weights) of the trained machine learning models are stored in the external memory bank 204. That way, the capabilities of the models on earlier tasks can be easily and effectively retained, avoiding the catastrophic forgetting encountered with conventional approaches.

According to one exemplary embodiment, the machine learning model architecture employed herein is a transformer model. In general, a transformer model is a neural network that learns context and meaning by tracking relationships in sequential data, such as the sequence of words in a sentence. Referring briefly to FIG. 3, general fully-connected feed-forward neural network 300 is provided. As shown in FIG. 3, neural network 300 includes a plurality of interconnected processor elements 302, 304/306 and 308 that form an input layer, at least one hidden layer, and an output layer, respectively, of the neural network 300. The connections in neural networks that carry electronic messages between simulated neurons are provided with numeric weights that correspond to the strength or weakness of a given connection. These numeric weights can be adjusted and tuned based on experience, making neural networks adaptive to inputs and capable of learning. Typically, neural networks are trained on labeled sets of training data. Once trained, the neural network can be used for inference. Inference applies knowledge from a trained neural network model and uses it to infer a result. A fully connected layer (typically the last or last few layers in a neural network) is a layer where all of the inputs from one layer are connected to every activation unit of the next layer. The fully connected layer(s) compile the data extracted by previous layers of the neural network to form the final output.

However, as highlighted above, unlike conventional transformer-based applications the present transformer model is augmented with external memory bank 204. As will be described in detail below, embodiments are contemplated herein where system 200 adaptively calculates how much memory is required for each of the tasks being learned by the iterative knowledge distillation module 202. That way, the external memory bank 204 can be adaptively increased by only that amount needed for storing the parameters of the particular tasks at hand, thus avoiding the large memory requirements associated with prior attempts to overcome catastrophic forgetting. However, it is notable that while this approach to adaptive memory allocation is a beneficial tool that may be implemented in system 200 for improving efficiency, it is not a requirement of the present techniques. Namely, embodiments are contemplated herein where other memory allocation schemes are employed including, but not limited to, approaches where a uniform amount of memory is allocated to each of the tasks.

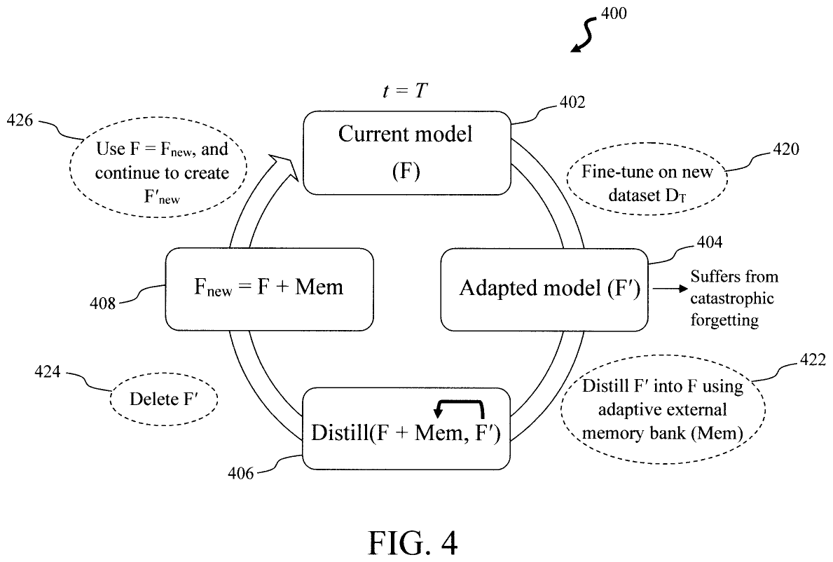

Given the above overview, FIG. 4 is a diagram illustrating an exemplary methodology 400 for incremental domain adaptation which can be performed by system 200 using iterative knowledge distillation module 202 and external memory bank 204. The term ‘distillation’ as used herein refers to the transfer of knowledge, whether it be from a teacher model to a student model (see below) or from a model to the external memory bank 204. As shown in FIG. 4, methodology 400 is an iterative process where machine learning models of the iterative knowledge distillation module 202 are trained on (i.e., adapted to) new tasks sequentially, and those learned capabilities (i.e., the parameters of the machine learning models pertaining to the new tasks) are stored in the memory slots of the external memory bank 204. Reference will be made herein to ‘teacher’ and ‘student’ machine learning models to leverage the understood nomenclature of knowledge distillation. Namely, knowledge distillation involves the transfer (i.e., distillation) of knowledge from a larger, more complex machine learning model to a smaller, less complex machine learning model. These more and less complex machine learning models are called the ‘teacher’ and ‘student,’ respectively. To illustrate this concept of knowledge distillation, in a typical scholastic environment a teacher has a wide variety of knowledge on different subject matters. For a particular lesson, the teacher will provide a student with the knowledge related to the subject matter of that lesson. In that same general manner, as will be described in detail below, a teacher machine learning model is iteratively trained on different domains. The knowledge for a particular one of these domains is then distilled into a student model and stored in the corresponding memory.

Reference will also be made herein to a ‘base’ model T and a ‘current’ model F. The base model T is the underlying machine learning model architecture without any of the external memory bank 204 attached to it. According to an exemplary embodiment, the base model T has a transformer architecture. By way of example only, suitable base model transformer architectures include, but are not limited to, pre-trained transformer machine learning models for natural language processing such as Bidirectional Representations from Transformers (BERT). The base model T is used for initialization, and is neither the teacher nor the student in this scenario. Notably, the weights of the base model T never change during the present iterative distillation process. It is the memory slots from external memory bank 204 that are added and updated, which work together with the base model T to make predictions. By contrast, the current model is the base model+all of the memory slots from external memory bank 204 that have been trained at any given point in time t. As provided above, methodology 400 is iterative. Thus, to use an illustrative example, at the end of iteration 4, the current model F is T+m1+m2+m3+m4 (where the + operator refers to the base model T and 4 sets of memory slots m in external memory bank 204), where mi is the collection of memory slots in external memory bank 204 that is trained during iteration i. The goal of iteration i is to learn a new domain di. That learning is then stored in the corresponding memory slots mi in external memory bank 204, such that T+mi together performs well on domain di. Notably, this (T+mi) architecture along with its trained weights is the student model for domain di.

Thus, as shown in FIG. 4, for iteration i methodology 400 begins with this current model F having a collection of associated memory slots m in external memory bank 204 (see block 402) and, in step 420, the current model F is fine-tuned (i.e., adapted) for a given new task (i.e., a current task) on a dataset D_{T} that represents the new task, producing an adapted model F′ (see block 404). Typically, adapting a model to a new task brings about the risk of catastrophic forgetting. Namely, the so-called adapted model is good on the current task it has adapted to, but has forgotten what it previously learned about older tasks.

However, in order to mitigate this forgetting, system 200 advantageously employs knowledge distillation into the external memory bank 204 in order to store the learning on previous tasks. Namely, as highlighted above, system 200 employs a teacher-student model paradigm where a more complex teacher machine learning model is used to ‘teach’ something it has learned to a less complex student machine learning model which does not have these capabilities. For instance, the teacher model might have knowledge about the financial domain, whereas the student model is a more general-purpose model. In addition to that aspect of knowledge distillation, i.e., from teacher model to student model, this knowledge is also distilled into the corresponding memory slots of external memory bank 204 in order store whatever the teacher model has currently learned.

Thus, referring to the example depicted in FIG. 4, according to the present techniques the adapted model F′ is used as the teacher model to distill what the adapted (teacher) model F′ has currently learned about the new task from dataset D_{T} to the current model F (which in this scenario is the student model without the new task capabilities) through the addition of new memory slots in external memory bank 204. According to an exemplary embodiment, what the adapted (teacher) model F′ has learned about the new task is embodied in the parameters (i.e., weights) of the adapted (teacher) model F′ which are distilled (i.e., transferred to/stored in) the external memory bank 204.

In other words, the present approach to knowledge distillation ensures that whatever incremental thing the adapted (teacher) model F′ has learned on top of the current model F is stored in the external memory bank 204 that has been added by system 200. Thus, in a sense, the external memory bank 204 has the capability of what the adapted (teacher) model F′ has learned on top of the current model F. By ‘external’ it is meant that memory bank 204 is external to the base model T. Advantageously, adding the external memory bank 204 mitigates catastrophic forgetting because the external memory bank 204 serves as a separate component, in addition to the current model F, that has learned this capability. It is notable that the current model F (which includes the older memory slots in external memory bank 204 which are frozen (and the base model T) will be the starting point for the next step, and training can proceed on the next new task, i.e., in each iteration the most recent adapted (teacher) model F′ gets thrown away (see below) and a new teacher model is trained in the next iteration.

Methodology is performed iteratively, whereby memory slots are added to external memory bank 204 for each of the tasks learned. As will be described in detail below, the filled memory slots are frozen to memorialize the learning on previous tasks. Further, as highlighted above, embodiments are contemplated herein where system 200 adaptively calculates how many memory slots are needed to store the parameters (i.e., weights) for each of the tasks on a task-by-task basis. For instance, storing easier tasks having less data requires fewer slots than for harder tasks with more data. Adaptively allocating memory in this manner maximizes the capacity of external memory bank 204 since only the required number of memory slots are added to the external memory bank 204 at each iteration.

This knowledge distillation using the (adaptive) external memory bank 204 is performed in step 422. Namely, as highlighted above, in step 422 the adapted (teacher) model F′ is distilled into the current model F using new memory slots that are added to the (adaptive) external memory bank 204 (Mem) (see block 406). Doing so mitigates the risk of catastrophic forgetting. In other words, the current model F is a union of the base model T (whose parameters, i.e., weights, are never updated) and memory slots in the external memory bank 204 (Mem). During knowledge distillation, only the new memory slots added to the external memory bank 204 are updated for the current task. The student model in this scenario is thus the current model F (from the previous iteration) and the new memory slots. As provided above, the adapted model F′ is the teacher model. As such, the knowledge of the current task is distilled into the current (student) model F by updating the new memory slots in the external memory bank 204 so that the current (student) model F can access these new memory slots for use in the new domain/task.

Since the new memory slots in external memory bank 204 are now attached to the current model F, following this knowledge distillation (Distill(F+Mem, F′)) the adapted (teacher) model F′ is deleted in step 424. A new teacher model, e.g., adapted (teacher) model F′_{new}, will be trained in the next iteration.

Namely, as highlighted above, it is the current model F plus the associated memory slots in external memory bank 204 (Mem) that will be used as the current model, F_{new}, to start the next iteration of methodology 400, i.e., F_{new}=F+Mem (see block 408). Specifically, in step 426 the current model F is set at F_{new}, i.e., F=F_{new}, and steps 420-426 are re-iterated with F_{new} as the current model. As described in detail above, this involves training a new adapted (teacher) model F′_{new}.

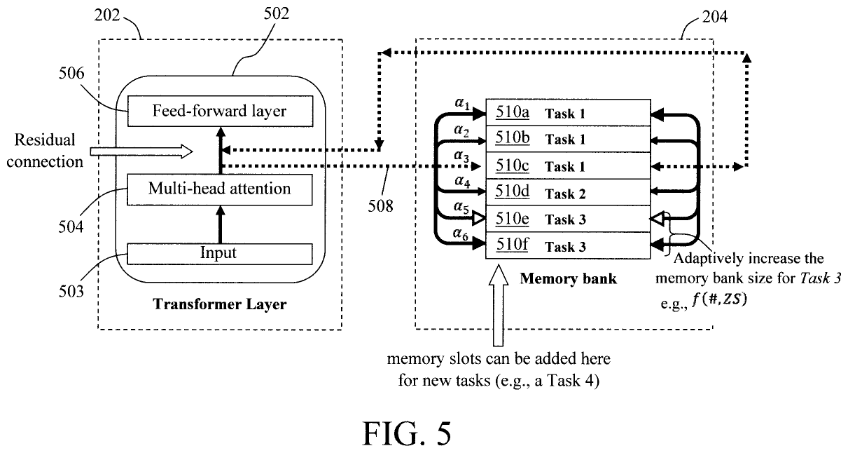

According to one exemplary embodiment, iterative knowledge distillation module 202 of system 200 employs a transformer model architecture for the base model T, current (student) model F, and adapted (teacher) model F′. A typical transformer model, however, does not have any associated memory which, as detailed above, is necessary for the present system 200 to store the capabilities of various different tasks learned by the model during incremental domain adaptation. Advantageously, it has been found herein that the computation in each layer of the transformer model can be augmented with additional memory. See, for example, FIG. 5. Namely, as shown in FIG. 5, in one exemplary embodiment access to external memory bank 204 is provided between a multi-head attention module 504 and downstream feed-forward layer 506 of the transformer architecture. Since knowledge distillation to the external memory bank 204 is performed by the adapted (teacher) model F′ (see description of methodology 400 above), then layer 502 shown in FIG. 5, along with the memory slots corresponding to a Task i, may be representative of a task-specific knowledge learned by the student model F from the teacher model F′ after the latter is adapted to Task i.

In general, a transformer model is a neural network that learns context and meaning by tracking relationships in sequential data. A transformer model can employ a multi-head attention module (such as multi-head attention module 504) which performs attention computations on input data 503 multiple times in parallel. The attention computations are then combined to produce a final attention score, which is then passed on to the feed-forward layer 506. However, as shown in FIG. 5, a residual connection can be implemented in between the multi-head attention module 504 and the feed-forward layer 506. In general, a residual connection is used to connect the output of one transformer layer to the input of another layer.

More specifically, according to the exemplary embodiment shown illustrated in FIG. 5 the output of the multi-head attention module 504 (e.g., an attention vector) is fed into the external memory bank 204 (see arrow 508), and used to induce a probability distribution over the memory slots 510a-f of the external memory bank 204. For instance, in the present example, the attention vector includes attention probabilities α₁-α₆ calculated by the multi-head attention module 504 that are used to re-weight the external memory bank 204. For example, if attention probability α₂ is larger than attention probability α₃ this tells the transformer model (i.e., via a higher attention weight) to pay more attention to memory slot 510b as compared to memory slot 510c. Thus, in this manner, the attention probabilities α₁-α₆ are used to weight the memory slots 510a-f of the external memory bank 204. A weighted sum over all values of the entire external memory bank 204 are then added back to transformer layer 502 in advance of the feed-forward layer 506.

This process enables the external memory bank 204 to be segmented based on tasks. For instance, in the example depicted in FIG. 5, memory slots 510a-c of the external memory bank 204 correspond to a first task (Task 1), memory slot 510d of the external memory bank 204 corresponds to a second task (Task 2), and memory slots 510e-f of the external memory bank 204 correspond to a third task (Task 3). In the next iteration i, given a new task (e.g., Task 4) slots (not shown) can be added to the external memory bank 204 that correspond to that Task 4 in order to distill F′ into the external memory bank 204, as described in conjunction with the description of step 422 of methodology 400 of FIG. 4 above. As such, when reference is made herein to ‘adding memory’ it is meant that memory slots are added to the external memory bank 204.

It is important to note that the memory slots of the external memory bank 204 regarding the previous tasks (e.g., memory slots 510a-c regarding Task 1, Task 2 and Task 3) are frozen (i.e., not re-written) thereby maintaining the stored capabilities on these previous tasks. Namely, the new memory slots added to the external memory bank 204 are used to distill the capabilities on new tasks (e.g., a Task 4).

As highlighted above and illustrated in FIG. 5, another beneficial feature of the present techniques is that system 200 can implement an adaptive increase of the external memory bank 204. Namely, as shown in the example depicted in FIG. 5, not all the tasks are allocated the same number of slots, i.e., Task 1 has three memory slots 510a-c, Task 2 has one memory slot 510d, and Task 3 has two memory slots 510e-f. This occurs because not all tasks are equal, e.g., some tasks are harder than others and require more data. According to an exemplary embodiment, system 200 adaptively decides, on the fly, how much memory from the external memory bank 204 needs to be allocated for each of the tasks. The notion here is that the lesser the amount of memory used the better, in order to comport with memory constraint requirements.

In one exemplary embodiment, system 200 adaptively calculates how many memory slots in the external memory bank 204 are required for a task as a function of quantities such as a number of instances of the task in the training dataset (e.g., dataset D_{T}) and/or discrepancy in zero-shot (ZS) performance and fine-tuning performance on the task. Namely, a dataset is a collection of examples/instances of a task. The number (#) of task instances in a given dataset is the number of examples in it. By way of example only, to calculate the performance difference, the adapted model F′ can be evaluated both before and after fine-tuning with the newest dataset, and take the difference. The larger this performance difference, the more new memory slots that are needed. The exact number of memory slots is a hyper-parameter that can be estimated empirically using validation experiments on a select set of initial tasks.

According to an exemplary embodiment, the external memory bank 204 is a collection of (key, value) pairs. More specifically, each memory slot 510a-f contains a key vector and a value vector. The key vector is used to compute the attention weight for memory retrieval (e.g., to determine whether a new incoming data item belongs to a particular domain), and the value vector is simply the value of the content stored in the given memory slot (e.g., parameter/weight value). For iteration i, an attention probability αᵢ can be computed as:

$${\tilde{α}}_{i , j} = exp \{ {h}_{i - 1}^{⊤} {m}_{j}^{( key )} \} , {α}_{i , j} = \frac{{\tilde{α}}_{i , j}}{{\sum }_{{j}^{′} = 1}^{N} {\tilde{α}}_{i , j ′}} ,$$

where mⱼ^{(key)} is the key vector of the jth memory slot of the external memory bank 204 (among N slots in total).

The key and value vectors are learned during model training. In the context of the present incremental domain adaptation approach, given a training dataset (e.g., dataset D_{T}) representing a domain di, all the (key, value) pairs associated with di will be learned. After training is over, the key vectors are responsible for ‘detecting’ whether a new incoming data item belongs to di. More specifically, during inference, given an input from domain di, the key vectors associated with domain di are expected to have higher attention weights so that their corresponding vector values will dominate the final computed value for that given input which, as provided above, is a weighted sum over all values of the entire external memory bank 204. According to an exemplary embodiment, the weight is the attention probability given by:

$${c}_{i} = {\sum }_{j = 1}^{N} {α}_{i , j} {m}_{j}^{( val )} ,$$

where m (val) is the value vector of the jth memory slot of the external memory bank 204, and cᵢ is the memory content.

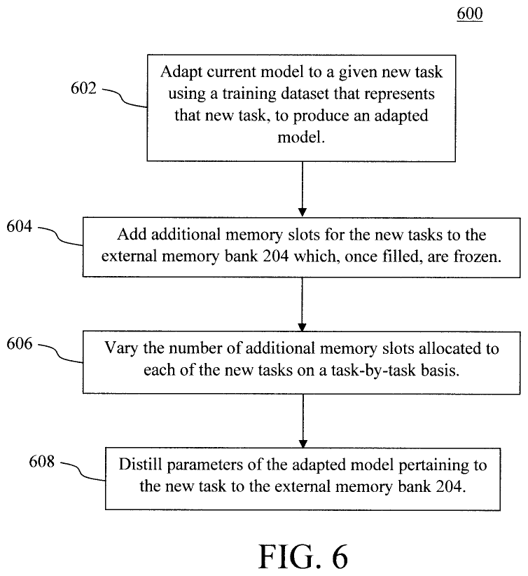

FIG. 6 is a diagram illustrating an exemplary methodology 600 for incremental domain adaptation performed, for example, using the present system 200. Methodology 600 generally involves sequentially finetuning/adapting the present machine learning (e.g., transformer) models to new tasks through multiple iterations of knowledge distillation as detailed above, and then storing the parameters of the machine learning models pertaining to the new tasks in memory slots added to the external memory bank 204. Specifically, for each iteration, in step 602 the current machine learning model F is adapted to a given one of the new tasks using a training dataset (e.g., dataset D_{T}) that represents that new task, producing an adapted machine learning model F′. This learned capability on the new task is then distilled to the current machine learning model F by way of adding new memory slots in the external memory bank 204 (Mem). Namely, in step 604, the external memory bank 204 adds additional memory slots for the new tasks. According to an exemplary embodiment, the external memory bank 204 employs adaptive memory allocation. When employing adaptive memory allocation, in step 606 the external memory bank 204 varies the number of additional memory slots allocated to each of the new tasks on a task-by-task basis. Using the example provided in FIG. 5 above as an illustration, doing so can result in one new task having a different number of memory slots in the external memory bank 204 than another new task. As provided above, the number of memory slots allocated to each of the new tasks can be determined as a function of one or more quantities such as, but not limited to, a number of instances of a new task in the training dataset, and a discrepancy in zero-shot performance and fine-tuning performance on the new task.

In step 608, parameters of the adapted machine learning model F′ pertaining to the new task are distilled to the external memory bank 204 by updating the newly added (see step 604 above) memory slots in external memory bank 204. Once filled, these memory slots are frozen. As described in detail above, following this knowledge distillation (Distill (F+Mem, F′)), the adapted machine learning model F′ is deleted.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A system for incremental domain adaptation, the system comprising:
an iterative knowledge distillation module configured to adapt machine learning models to new tasks sequentially through multiple iterations of knowledge distillation; and
an external memory bank configured to store parameters of the machine learning models pertaining to the new tasks.

2. The system of claim 1, wherein the machine learning models comprise a transformer architecture.

3. The system of claim 2, wherein a layer in the transformer architecture comprises a multi-head attention module and a feed-forward layer downstream from the multi-head attention module, and wherein the external memory bank is attached to the transformer architecture between the multi-head attention module and the feed-forward layer via a residual connection.

4. The system of claim 1, wherein for each of the multiple iterations the machine learning models comprise a current machine learning model and an adapted machine learning model, and wherein the iterative knowledge distillation module is further configured to adapt the current machine learning model to a given one of the new tasks using a training dataset that represents the given new task to produce the adapted machine learning model.

5. The system of claim 4, wherein the iterative knowledge distillation module is further configured to distill the parameters of the adapted machine learning model pertaining to the given new task to the external memory bank.

6. The system of claim 5, wherein the parameters of the adapted machine learning model pertaining to the given new task are stored in memory slots of the external memory bank.

7. The system of claim 6, wherein the memory slots, when filled, are frozen.

8. The system of claim 6, wherein the external memory bank is further configured to add additional memory slots for the new tasks.

9. The system of claim 8, wherein a number of the memory slots added is varied on a task-by-task basis.

10. A system for incremental domain adaptation, the system comprising:
an iterative knowledge distillation module configured to adapt machine learning models to new tasks sequentially through multiple iterations of knowledge distillation; and
an adaptive external memory bank configured to store parameters of the machine learning models pertaining to the new tasks in memory slots of the external memory bank, wherein a number of the memory slots allocated to each of the new tasks varies on a task-by-task basis such that a given one of the new tasks has a different number of the memory slots in the adaptive external memory bank than at least one other of the new tasks.

11. The system of claim 10, wherein the machine learning models comprise a transformer architecture, wherein a layer in the transformer architecture comprises a multi-head attention module and a feed-forward layer downstream from the multi-head attention module, and wherein the external memory bank is attached to the transformer architecture between the multi-head attention module and the feed-forward layer via a residual connection.

12. The system of claim 10, wherein for each of the multiple iterations the machine learning models comprise a current machine learning model and an adapted machine learning model, and wherein the iterative knowledge distillation module is further configured to adapt the current machine learning model to a given one of the new tasks using a training dataset that represents the given new task to produce the adapted machine learning model.

13. The system of claim 12, wherein the iterative knowledge distillation module is further configured to distill the parameters of the adapted machine learning model pertaining to the given new task to the external memory bank.

14. The system of claim 12, wherein the number of the memory slots allocated to each of the new tasks is a function of at least one of a number of instances of the given new task in the training dataset, and discrepancy in zero-shot performance and fine-tuning performance on the given new task.

15. The system of claim 10, wherein the memory slots, when filled, are frozen.

16. The system of claim 10, wherein the external memory bank is further configured to add additional memory slots for the new tasks.

17. A method for incremental domain adaptation, the method comprising:
adapting machine learning models to new tasks sequentially through multiple iterations of knowledge distillation; and
storing parameters of the machine learning models pertaining to the new tasks in an external memory bank.

18. The method of claim 17, further comprising:
adapting, for each of the multiple iterations, a current one of the machine learning models to a given one of the new tasks using a training dataset that represents the given new task to produce an adapted one of the machine learning models; and
distilling the parameters of the adapted one of the machine learning models pertaining to the given new task to the external memory bank

19. The method of claim 17, wherein the parameters of the adapted one of the machine learning models pertaining to the given new task are stored in memory slots of the external memory bank, and wherein the method further comprises:
adding additional memory slots to the external memory bank for the new tasks.

20. The method of claim 19, wherein the method further comprises:
varying a number of the additional memory slots allocated to each of the new tasks on a task-by-task basis such that a given one of the new tasks has a different number of the memory slots in the adaptive external memory bank than at least one other of the new tasks, and wherein the number of the memory slots allocated to each of the new tasks is a function of at least one of a number of instances of the given new task in the training dataset, and discrepancy in zero-shot performance and fine-tuning performance on the given new task.
